(19) United States
(12) Patent Application Publication
(10) Pub. No.: US 2012/0206702 A1
(43) Pub. Date: Aug. 16, 2012

(54) COMPUTER-READABLE RECORDING MEDIUM RECORDING EXPOSING CONDITION DETERMINATION PROGRAM

(76) Inventor: Kazuya FUKUHARA, Tokyo (JP)

(21) Appl. No.: 13/229,069

(22) Filed: Sep. 9, 2011

(30) Foreign Application Priority Data
Feb. 15, 2011 (JP) 2011-029880

(51) Int. Cl. G03B 27/54

(52) U.S. Cl. 355/67

(57) ABSTRACT

Certain embodiments provide a computer-readable recording medium recording an exposing condition determination program. The program allows a computer to perform: a first step of dividing an illumination pupil into a plurality of regions; a second step of calculating, for each region, an imaging performance response indicative of relation between a brightness change from a first illumination shape and a change in an imaging performance evaluation amount for a transfer pattern; a third step of finding a brightness change amount for each region so that the imaging performance evaluation amount is maintained in a specified range; a fourth step of adding the brightness change amount to the first illumination shape to find a second illumination shape; and a step of performing the first to the fourth steps multiple times while changing a calculation condition parameter to find a second illumination shape as an illumination shape supplied to the exposure apparatus.

### CROSS REFERENCE TO RELATED APPLICATION

This application is based upon and claims benefit of priority from the Japanese Patent Application No. 2011-29880, filed on Feb. 15, 2011, the entire contents of which are incorporated herein by reference.

### FIELD

Embodiments described herein relate generally to a computer-readable recording medium recording a program which determines exposure conditions.

### BACKGROUND

Recently, some exposure apparatuses are known to be capable of changing illumination shapes. An exposure process in the manufacture of semiconductor integrated circuits requires transforming a predetermined illumination shape and designing an optimal illumination shape in accordance with mask and process conditions to be used. For example, a conventional technique has designed an illumination shape using an exposure simulation so that dimensions and a process allowance error satisfy specified values for important transfer patterns included in a semiconductor integrated circuit. However, there may be a case where a transfer pattern not considered in the simulation does not provide sufficient transfer performance. In such a case, the technique incorporates the transfer pattern incapable of sufficient transfer performance into calculation conditions and re-designs an illumination shape.

However, increasing the number of transfer patterns to be considered also increases the time required for the illumination design. It is impractical to design an illumination shape in consideration of all transfer patterns contained in a semiconductor integrated circuit because a large amount of calculations is needed.

### BRIEF DESCRIPTION OF THE DRAWINGS

FIG. 1 is a hardware configuration diagram illustrating an exposing condition determination apparatus according to a first embodiment of the invention;

FIG. 2 is a diagram illustrating an example of an exposure apparatus;

FIG. 3 is a function block diagram that can be implemented by executing an exposing condition determination program according to the first embodiment of the invention;

FIG. 4 is a flowchart illustrating an exposing condition determination method according to the first embodiment of the invention;

FIG. 5A is a diagram illustrating an example of dividing an illumination pupil; and

FIG. 5B is a diagram illustrating an example of dividing an illumination pupil.

### DETAILED DESCRIPTION

According to one embodiment, a computer-readable recording medium records an exposing condition determination program. The exposing condition determination program allows a computer to perform: a first step of dividing an illumination pupil into a plurality of regions; a second step of calculating, for each of the regions, an imaging performance response indicative of relation between a brightness change from a first illumination shape and a change in an imaging performance evaluation amount for a transfer pattern when brightness is changed; a third step of using the imaging performance response and finding a brightness change amount for each region so that the imaging performance evaluation amount is maintained in a specified range; a fourth step of adding the brightness change amount to the first illumination shape to find a second illumination shape; and a step of performing the first to the fourth steps multiple times while changing a calculation condition parameter to find a plurality of second illumination shapes corresponding to calculation condition parameters and selecting a second illumination shape having a smallest difference from the first illumination shape as an illumination shape supplied to the exposure apparatus.

Embodiments of the present invention will be described in further detail with reference to the accompanying drawings.

### First Embodiment

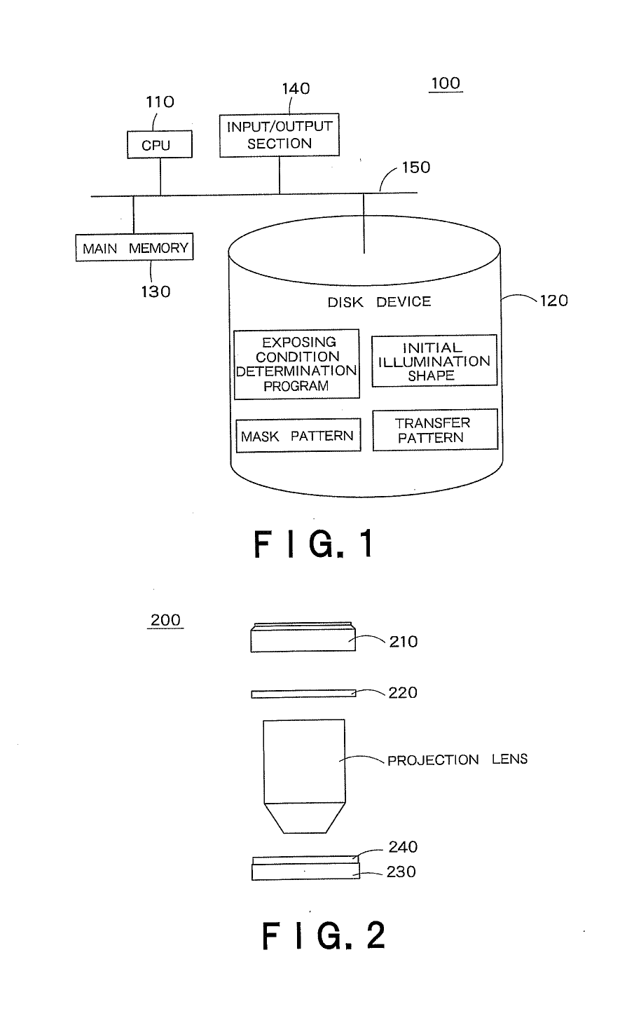

FIG. 1 illustrates a hardware configuration of an exposing condition determination apparatus according to a first embodiment of the invention. An exposing condition determination apparatus 100 includes a CPU (central processing unit) 110, a disk device 120, main memory 130, and an input/output section 140. The components of the exposing condition determination apparatus 100 are connected to each other through a bus 150. FIG. 2 shows an exposure apparatus 200 including a light source 210 that can provide variable illumination shapes. The exposing condition determination apparatus 100 allows the light source 210 to determine an illumination shape appropriate to a pattern of a mask 220 used for an exposure process.

The disk device 120 shown in FIG. 1 stores an exposing condition determination program executed by the CPU 110. The disk device 120 further stores mask patterns (those for the mask 220), initial illumination shapes for the light source 210 corresponding to the mask patterns, and information about transfer patterns to be transferred onto a resist 240 on a substrate 230. The disk device 120 is equivalent to a hard disk, for example. The exposing condition determination program may be stored on not only the disk device 120, but also ROM or magnetic tape (not shown).

The CPU 110 loads the exposing condition determination program from the disk device 120 to the main memory 130 and executes the exposing condition determination program. At this time, the CPU 110 may load the initial illumination shape, the mask pattern, and the transfer pattern from the disk device 120 to the main memory 130.

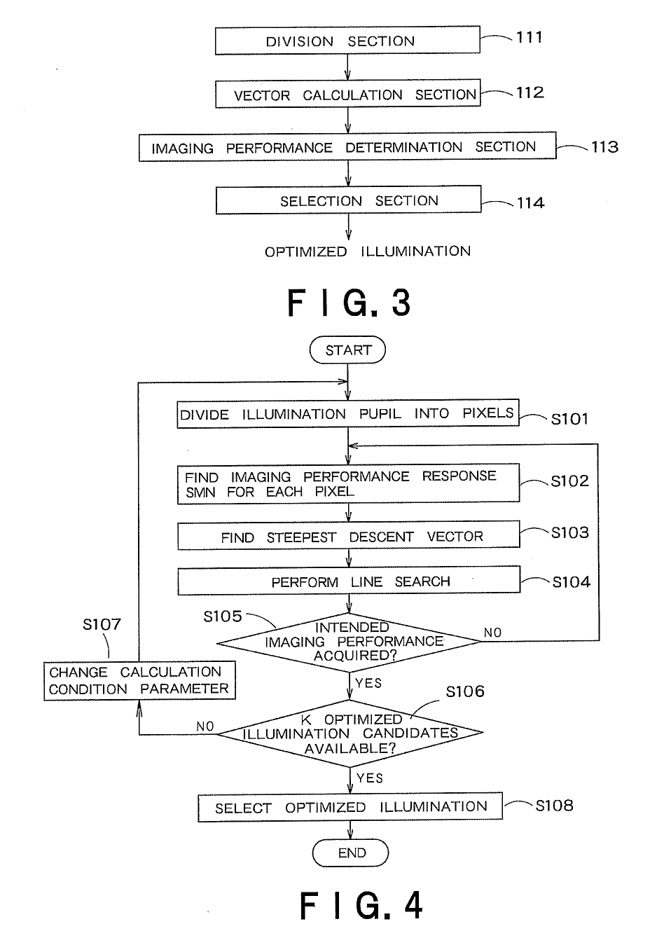

FIG. 3 shows a function block diagram the CPU 110 implements by performing the exposing condition determination program. Performing the exposing condition determination program implements a division section 111, a vector calculation section 112, an imaging performance determination section 113, and a selection section 114.

With reference to a flowchart in FIG. 4, the following describes processes performed in the division section 111, the vector calculation section 112, the imaging performance determination section 113, and the selection section 114.

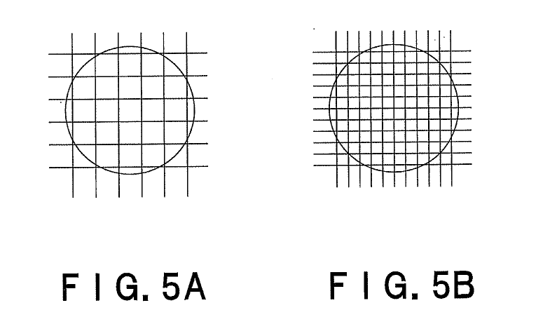

(Step S101) The division section 111 divides the illumination pupil of the light source 210 into pixels. As shown in FIG. 5A, for example, the division section 111 divides the illumination pupil into an orthogonal grid pattern.

(Step S102) The vector calculation section 112 selects M types of imaging performance evaluation amounts, where M is 1 or larger integer. The imaging performance evaluation amount provides an index for evaluating the imaging performance of a targeted transfer pattern. For example, the imaging performance evaluation amounts include the exposure level (EL), the depth of focus (DOF), the critical dimension (CD) for each pattern type, the Zernike sensitivity (ZS) as the size change sensitivity with reference to projection lens aberration, the SRAF printability factor (SPF) as the assist pattern transfer property, the mask error enhancement factor (MEEF), and the optimum exposure dosage (Eop). Of these amounts, CD, ZS, SPF, and MEEF are defined for each of the targeted transfer patterns. EL and DOF may be defined for each of the targeted transfer patterns or may be defined as common EL and common DOF, that is, amounts common to all or parts of transfer patterns. Eop is provided with one value regardless of types or the number of transfer patterns.

Using exposure simulation, the vector calculation section 112 calculates imaging performance response sₘₙ for each of N pixels divided at step S101, where N is 2 or larger integer. Imaging performance response sₘₙ indicates relation between brightness change ΔIₙ in the nth pixel from the initial illumination, where n is an integer satisfying 1≦n≦N, and a change in the mth imaging performance evaluation amount ΔIPₘ, where m is an integer satisfying 1≦m≦M. Imaging performance response sₘₙ can be found from equation 1 below.

$${s}_{mn} = \frac{\partial {IP}_{m}}{\partial {I}_{n}} \approx \frac{Δ {IP}_{m}}{Δ {I}_{n}} \qquad [ Equation 1 ]$$

IPₘ denotes the mth imaging performance evaluation amount. Iₙ denotes the brightness of the nth pixel in the illumination pupil. The symbol “≈” denotes approximation. The equation uses a delta (small difference) value instead of a differential value in a strict sense.

The vector calculation section 112 calculates imaging performance response sₘₙ for each of the first to the Nth illumination pixels based on the first to the Mth imaging performance evaluation amounts. The imaging performance response sₘₙ to be calculated can be represented by matrix S, referred to as sensitivity matrix S, as shown in equation 2 below.

$$S = ( \begin{matrix}{s}_{11} & {s}_{12} & … & {s}_{1 N} \\ {s}_{21} & {s}_{22} & … & {s}_{2 N} \\ ⋮ & ⋮ & ⋮ & ⋮ \\ {s}_{M 1} & {s}_{M 2} & … & {s}_{MN }\end{matrix} ) \qquad [ Equation 2 ]$$

(Step S103) Equation 3 below can express relation between a change in the brightness of the illumination pixel and a change in the imaging performance evaluation amount.

$$( \begin{matrix}Δ {IP}_{1} \\ Δ {IP}_{2} \\ ⋮ \\ Δ {IP}_{M}\end{matrix} ) = ( \begin{matrix}{s}_{11} & {s}_{12} & … & {s}_{1 N} \\ {s}_{21} & {s}_{22} & … & {s}_{2 N} \\ ⋮ & ⋮ & ⋮ & ⋮ \\ {s}_{M 1} & {s}_{M 2} & … & {s}_{MN}\end{matrix} ) ( \begin{matrix}Δ {I}_{1} \\ Δ {I}_{2} \\ ⋮ \\ Δ {I}_{N}\end{matrix} ) + ( \begin{matrix}{ɛ}_{1} \\ {ɛ}_{2} \\ ⋮ \\ {ɛ}_{M}\end{matrix} ) \qquad [ Equation 3 ]$$

In this equation, εₘ denotes a difference (fitting residual error) between a true value for variation ΔIPₘ and an approximation when a linear combination of brightness change ΔIₙ with imaging performance response sₘₙ is used to approximate variation ΔIPₘ in the imaging performance evaluation amount. Equation 3 can be transformed into equation 4 as follows.

$$y = Sx + ɛ , where y = ( \begin{matrix}Δ {IP}_{1} \\ Δ {IP}_{2} \\ ⋮ \\ Δ {IP}_{M}\end{matrix} ) , \\ x = ( \begin{matrix}Δ {I}_{1} \\ Δ {I}_{2} \\ ⋮ \\ Δ {I}_{M}\end{matrix} ) , ɛ = ( \begin{matrix}{ɛ}_{1} \\ {ɛ}_{2} \\ ⋮ \\ {ɛ}_{M}\end{matrix} ) \qquad [ Equation 4 ]$$

In equation 4, vector y is referred to as an imaging performance change vector. Vector x is referred to as an illumination brightness change vector. Vector ε is referred to as a residual error vector. Equation 5 below defines cost function R in the initial state.

R=|y|² [Equation 5]

All elements in vector y are 0 and cost function R is also 0 when the current imaging performance evaluation amount matches a target value. The value of R increases as a difference between the current imaging performance evaluation amount and the target value increases.

The vector calculation section 112 uses the least-square method to find a combination of brightness change amounts ΔI₁ through ΔI_{N} in order to keep differences ΔIP₁ through ΔIP_{M} between the imaging performance evaluation amount and the target value within a specified range of values. That is, the vector calculation section 112 finds illumination brightness change vector X for minimizing the size of residual error vector ε when vector Y containing specified values for ΔIP₁ through ΔIP_{M} is substituted for imaging performance change vector y in equation 4. Such illumination brightness change vector X is found by equation 6 as follows.

X=(S′S)⁻¹S′Y [Equation 6]

where S^{t} denotes the transposed matrix for matrix S. Techniques for performing the numeric calculation in equation 6 include the singular value decomposition method, for example. Resulting vector X is referred to as a steepest descent vector because it indicates a direction of fastest minimizing the size of cost function R in an M-dimensional space.

(Step S104) The vector calculation section 112 adds a constant multiple of steepest descent vector X found at step S103 to an initial illumination shape and verifies variations in cost function R. In equation 7 below, the vector calculation section 112 varies coefficient α to generate illumination shape I and calculates cost function R for multiple illumination shapes I corresponding to varied coefficients α.

I=I₀+α·X [Equation 7]

where I₀ denotes the initial illumination shape. For example, the vector calculation section 112 varies α in increments of a specified value within the range of 0≦α≦1 to find illumination shape I and calculate cost function R. The range of 0≦α≦1 is appropriate for retrieving α but may be expanded. This technique is referred to as a line search because it searches a straight line defined in the M-dimensional space.

The vector calculation section 112 finds coefficient α for minimizing cost function R and assumes illumination shape I at that time to be “improved illumination.”

(Step S105) The imaging performance determination section 113 determines whether the imaging performance satisfies a specified condition under the improved illumination found at step S104. For example, the imaging performance determination section 113 determines whether cost function R is less than a specified threshold value. Alternatively, the imaging performance determination section 113 calculates each of imaging performance evaluation amounts and determines whether all the imaging performance evaluation amounts satisfy a specified criterion.

The imaging performance determination section 113 stores the improved illumination as an optimized illumination candidate in the main memory 130 and proceeds to step S106 when the imaging performance satisfies the specified condition under the improved illumination.

Control returns to step S102 when the imaging performance does not satisfy the specified condition. The initial illumination is replaced by the improved illumination found at step S104. Then, steps S102 through S104 are repeated. The technique of repeating calculation of the steepest descent vector at step S103 and the line search at step S104 is known as an “optimal gradient method (OGM)” for solving nonlinear optimization problems.

Depending on a case, the relation between imaging performance change ΔIPₘ and brightness change ΔIₙ may not be linear. Changing steepest descent vector X may not provide the intended imaging performance due to effects such as two- or higher-dimensional dependencies or an interaction dependent on the brightness (e.g., ΔIPₘ₊₁) of the other pixel. Even in such a case, the embodiment can ensure the optimization by repeating steps S102 through S104 to repeatedly perform the optimization calculation based on the linear approximation.

(Step S106) Control proceeds to step S107 when the main memory 130 stores fewer than k optimized illumination candidates, where k is 2 or larger integer. Control proceeds to step S108 when the main memory 130 stores k optimized illumination candidates.

(Step S107) The process changes one or more calculation condition parameters at steps S101 through S106 and repeats steps S101 through S106. For example, the division method for the division section 111 may be changed as a change in the calculation condition parameter. The division section 111 may perform the division based on a division pitch as shown in FIG. 5B different from that as shown in FIG. 5A. Changes in the division method may include not only the division pitch, but also a division position or a division shape. As another example of the calculation condition parameter, the initial illumination shape may be changed to create a second initial illumination that may be then used for the calculations at step S102 and later. The specified illumination shape may be changed manually to any shape or may be changed to the optimized illumination candidate found at step S106. As yet another example of the calculation condition parameter, the size of brightness change ΔIₙ may be changed at step S102.

At step S101, a different division method is used to divide the illumination pupil into pixels. Changing the division method also changes optimized illumination candidates found at step S105.

At step S101, different division methods are used to generate k optimized illumination candidates.

(Step S108) The selection section 114 selects an optimized illumination from the k optimized illumination candidates stored in the main memory 130. The optimized illumination shows the smallest difference from the initial illumination. This is because decreasing a difference from the initial illumination can suppress degradation of the imaging performance of the transfer pattern while the degradation is not considered in the exposure simulation.

For example, the selection section 114 finds a difference between the initial illumination and an optimized illumination candidate. The selection section 114 calculates an RMS (root-mean-square) of the difference as an illumination change index. The selection section 114 selects an optimized illumination candidate having the smallest illumination change index as the optimized illumination.

The illumination change index may use not only the RMS of a difference between the initial illumination and an optimized illumination candidate but also the linear transformation amount (e.g., 1−C) of a brightness correlation coefficient (C) between the initial illumination and an optimized illumination candidate, for example.

The optimized illumination selected by the selection section 114 is supplied to the light source 210 of the exposure apparatus 200 to perform an exposure process. Such an exposure process can improve the dimension accuracy and the shape fidelity of transfer patterns.

The embodiment does not increase the number of transfer patterns to be considered in the exposure simulation. The embodiment can ensure the amount of illumination shape adjustment in a short time period through a relatively small number of calculations in order to provide the intended imaging performance of a pattern to be transferred onto the substrate.

At the development stage, the embodiment makes it possible to design an illumination shape capable of excellent dimension accuracy in a short time period. At the mass production stage, the embodiment can improve the dimension accuracy and the shape fidelity of transfer patterns in a short time period and therefore can shorten the lead time for the mass production.

At the mass production stage, the embodiment can determine the amount of exposure apparatus adjustment in a short time period in order to suppress a transfer performance difference between exposure apparatuses and correct a chronological change in the imaging performance. The embodiment can improve the semiconductor device productivity while minimizing the time to stop the exposure apparatus.

It is preferable to use normalized IPₘ because the embodiment equally evaluates different types of imaging performance evaluation amounts. Normalized IPₘ can be represented by dividing the IPₘ variation by a permissible error. For example, let us suppose that IPₘ is equivalent to the exposure level of a given transfer pattern, that the IPₘ variation is set to 1%, and that the permissible error is set to ±0.2%. Then, normalized IPₘ is calculated as 1/0.2=5.

### Second Embodiment

The above-mentioned first embodiment finds multiple optimized illumination candidates by changing the division method at step S101 and selects an optimized illumination having the smallest illumination change index out of the candidates. It may be also preferable to previously assume an illumination change index to be imaging performance evaluation amount IPₘ. Increasing the illumination change index also increases cost function R.

In this case, the division method at step S101 need not be changed. An optimized illumination candidate found from one division method is assumed to be the optimized illumination as is. This is because the second embodiment provides a small illumination change index for the improved illumination (optimized illumination candidate) found at step S105. A flowchart of the exposing condition determination method according to the embodiment is equivalent to the flowchart in FIG. 4 with steps S106 through S108 excluded.

Step S108 may provide multiple illumination candidates having nearly equal small differences from the initial illumination. In this case, for example, the process can select an illumination candidate that enables imaging performance approximate to the intended value or indicates a small difference from the intended state.

### First Modification of the First and Second Embodiments

The first and second embodiments have described the optimization examples using the so-called “gradient method” that searches for a steepest descent vector about the initial value and finds an appropriate solution along the direction toward the steepest descent vector. In addition, a different optimization method can be used to search for a state that decreases cost function R. For example, it is possible to use a heuristic optimization method such as the genetic algorithm (GA) or the simulated annealing method.

The genetic algorithm assumes a design parameter set to be a “gene.” Starting from the initial state, a step generates a new gene by performing such operations as recombination and mutation. Another step selects a few genes having a smaller cost function from the generated genes. The genetic algorithm repeats theses steps to find an optimal solution.

According to the simulated annealing method, a step generates changes with reference to the initial state using random numbers and calculates a cost function. Another step compares cost function values between the original state and a new state and selects the new state in accordance with a transition probability dependent on a cost function difference. The simulated annealing method repeats these steps to find an optimal solution.

### Second Modification of the First and Second Embodiments

It may be preferable to add a step of transforming the mask pattern between steps S104 and S105 of the flowchart shown in FIG. 4. As a known technique, OPC (Optical Proximity Correction) is used to adjust mask dimensions in order to simultaneously change dimensions of multiple types of transfer patterns with different pitches or shapes.

At step S104, it is desirable to appropriately correct dimensions of multiple types of transfer patterns with different pitches or shapes in accordance with transformation of the illumination shape. However, the dimensions cannot be always corrected sufficiently owing to restrictions resulting from improvement of the other imaging performance factors. In such a case, the OPC can further improve the dimension accuracy of transfer patterns.

The above-mentioned exposing condition determination program may be stored in a recording medium such as a flexible disk or a CD-ROM, loaded into a computer, and executed. The recording medium is available as not only a detachable medium such as a magnetic disk or an optical disk but also an undetachable medium such as a hard disk device or a memory chip.

The exposing condition determination program may be delivered via a communication line (including wireless communication) such as the Internet. The exposing condition determination program may be encrypted, modulated, or compressed when it is delivered via a wired or wireless communication line such as the Internet or supplied as a recording medium that stores the program.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A computer-readable recording medium recording a program which determines exposure conditions including an illumination shape for an exposure apparatus,
wherein the program allows a computer to perform:
a first step of dividing an illumination pupil into a plurality of regions;
a second step of calculating, for each of the regions, an imaging performance response indicative of relation between a brightness change from a first illumination shape and a change in an imaging performance evaluation amount for a transfer pattern when brightness is changed;
a third step of using the imaging performance response and finding a brightness change amount for each region so that the imaging performance evaluation amount is maintained in a specified range;
a fourth step of adding the brightness change amount to the first illumination shape to find a second illumination shape; and
a step of performing the first to the fourth steps multiple times while changing a calculation condition parameter to find a plurality of second illumination shapes corresponding to calculation condition parameters and selecting one second illumination shape as an illumination shape supplied to the exposure apparatus.

2. The computer-readable recording medium according to claim 1,
wherein the second illumination shape having a smallest difference from the first illumination shape is selected as the illumination shape supplied to the exposure apparatus.

3. The computer-readable recording medium according to claim 2,
wherein the program allows a computer to select an illumination shape to be provided for the exposure apparatus from the second illumination shapes based on a difference from the first illumination shape.

4. The computer-readable recording medium according to claim 1,
wherein the program allows a computer to select an illumination shape to be provided for the exposure apparatus based on a difference from specified imaging performance.

5. The computer-readable recording medium according to claim 1,
wherein the calculation condition parameter is at least one of a change in the first illumination shape, a division method of the illumination pupil, and a calculation method for the imaging performance response.

6. The computer-readable recording medium according to claim 1,
wherein the step of dividing an illumination pupil into a plurality of regions divides the illumination pupil into an orthogonal grid pattern, and
wherein a change in the calculation condition parameter is equivalent to a change in one of a division pitch and a division position of the illumination pupil.

7. The computer-readable recording medium according to claim 1,
wherein the program uses the imaging performance evaluation amount such as at least one of an exposure level, a depth of focus, a critical dimension for each pattern type, a size change sensitivity for a transfer pattern in relation to projection lens aberration of the exposure apparatus, an assist pattern transfer property, a mask error enhancement factor, and an optimum exposure dosage.

8. A computer-readable recording medium recording a program which determines exposure conditions including an illumination shape for an exposure apparatus,
wherein the program allows a computer to perform:
a step of dividing an illumination pupil into a plurality of regions;
a step of calculating, for each of the regions, an imaging performance response indicative of relation between a brightness change from a first illumination shape and a change in an imaging performance evaluation amount for a transfer pattern when brightness is changed;
a step of using the imaging performance response and finding a brightness change amount for each region so that the imaging performance evaluation amount is maintained in a specified range; and
a step of adding the brightness change amount to the first illumination shape to find a second illumination shape to be provided for the exposure apparatus; and
wherein the imaging performance evaluation amount contains an illumination change index indicative of a difference from the first illumination shape.

9. The computer-readable recording medium according to claim 8,
wherein the program uses the imaging performance evaluation amount such as at least one of an exposure level, a depth of focus, a critical dimension for each pattern type, a size change sensitivity for a transfer pattern in relation to projection lens aberration of the exposure apparatus, an assist pattern transfer property, a mask error enhancement factor, and an optimum exposure dosage.
